(19) United States
(12) Patent Application Publication
(10) Pub. No.: US 2026/0019721 A1
(43) Pub. Date: Jan. 15, 2026

(54) IMAGE SENSING DEVICE

(71) Applicant: SK hynix Inc., Icheon-si (KR)

(72) Inventor: Dong Ho HA, Icheon-si (KR)

(21) Appl. No.: 19/195,067

(22) Filed: Apr. 30, 2025

(30) Foreign Application Priority Data
Jul. 10, 2024 (KR) 10-2024-0091005

(51) Int. Cl. H04N 25/51; H04N 23/667; H04N 25/77

(52) U.S. Cl. CPC H04N 25/51; H04N 23/667; H04N 25/77

(57) ABSTRACT

Image sensing devices are disclosed. In an embodiment, an image sensing device includes a pixel region including unit pixels configured to convert incident light into an electrical signal; and a row driver configured to change a well capacity of a photoelectric conversion element disposed in at least one of the unit pixels and a conversion gain of the at least one of unit pixels for converting photocharge generated in response to incident light into a voltage of a pixel signal at each unit pixel to correspond to a selected operation mode upon receiving a mode selection signal that selects an operation mode of the unit pixels. The image sensing device can improve its operating characteristics thereof by modifying its light-receiving characteristics depending on the photography setting or shooting environment.

### CROSS-REFERENCE TO RELATED APPLICATION

This patent document claims the priority and benefits of Korean patent application No. 10-2024-0091005, filed on Jul. 10, 2024, which is incorporated by reference in its entirety as part of the disclosure of this patent document.

### TECHNICAL FIELD

The technology and implementations disclosed in this patent document generally relate to an image sensing device.

### BACKGROUND

Image sensors are used in electronic devices to convert optical images into electrical signals. With the recent development of automotive, medical, computer and communication industries, the demand for highly integrated, higher-performance image sensors has been rapidly increasing in various electronic devices such as digital cameras, camcorders, personal communication systems (PCSs), video game consoles, surveillance cameras, medical micro-cameras, robots, etc.

As the demand for image sensors increases and their range of applications expands, there is also a growing needs for image sensors that can be used in various photography setting or shooting environment.

### SUMMARY

Various embodiments of the disclosed technology relate to an image sensing device with adjustable light-receiving characteristics depending on the photography setting or shooting environment.

In an embodiment of the disclosed technology, an image sensing device may include a pixel region including unit pixels configured to convert incident light into an electrical signal; and a row driver configured to change a well capacity of a photoelectric conversion element disposed in at least one of the unit pixels and a conversion gain of the at least one of the unit pixels for converting photocharges generated in response to incident light into a voltage of a pixel signal at each unit pixel to correspond to a selected operation mode upon receiving a mode selection signal that selects an operation mode of the unit pixels.

In another embodiment of the disclosed technology, an image sensing device may include a photoelectric conversion element configured to generate photocharges in response to incident light; a transfer transistor configured to transfer the photocharges generated by the photoelectric conversion element to a floating diffusion region based on a transfer control signal; a first capacitor having a first capacitance; a second capacitor having a second capacitance different from the first capacitance; a first conversion gain (CG) transistor configured to selectively connect the first capacitor to the floating diffusion region based on a first gain control signal; and a second conversion gain (CG) transistor configured to selectively connect the second capacitor to the floating diffusion region based on a second gain control signal.

It is to be understood that both the foregoing general description and the following detailed description of the disclosed technology are illustrative and explanatory and are intended to provide further explanation of the disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an image sensing device based on some implementations of the disclosed technology.

FIG. 2 is a circuit diagram illustrating an example of a unit pixel formed in a pixel region of FIG. 1 based on some implementations of the disclosed technology.

FIG. 3 is a circuit diagram schematically illustrating configurations for changing light-receiving characteristics of unit pixels in the image sensing device of FIG. 1 based on some implementations of the disclosed technology.

FIG. 4 is a timing diagram illustrating changes in control signals, a conversion gain, a well capacity, and an off-voltage according to changes in the operation modes shown in FIG. 3 based on some implementations of the disclosed technology.

FIG. 5A is a diagram illustrating examples of electric potential distributions of a photoelectric conversion element (PD), a transfer transistor (TX), and a floating diffusion region (FD) in a high conversion gain (HCG) mode based on some implementations of the disclosed technology.

FIG. 5B is a diagram illustrating examples of electric potential distributions of a photoelectric conversion element (PD), a transfer transistor (TX), and a floating diffusion region (FD) in a low conversion gain (LCG) mode based on some implementations of the disclosed technology.

FIG. 6 is a timing diagram illustrating changes in control signals, a conversion gain, a well capacity, and an off-voltage based on some implementations of the disclosed technology.

### DETAILED DESCRIPTION

This patent document provides implementations and examples of an image sensing device that may be used to substantially address one or more technical or engineering issues and mitigate limitations or disadvantages encountered in some other image sensing devices. Some implementations of the disclosed technology suggest examples of an image sensing device that can vary light-receiving characteristics depending on the photographing environment. In recognition of the issues above, the disclosed technology provides various implementations of the image sensing device that can improve the operating characteristics thereof by changing light-receiving characteristics depending on the photographing environment.

Reference will now be made in detail to certain embodiments, examples of which are illustrated in the accompanying drawings. Wherever possible, the same reference numbers will be used throughout the drawings to refer to the same or similar parts. In the following description, a detailed description of related known configurations or functions incorporated herein will be omitted to avoid obscuring the subject matter.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

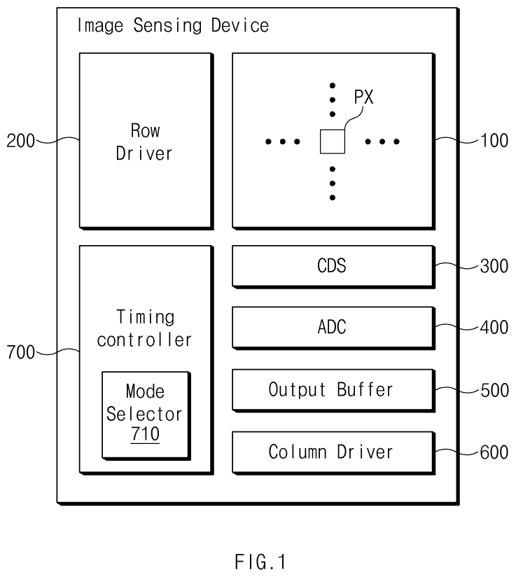

FIG. 1 is a block diagram illustrating an example of an image sensing device based on some implementations of the disclosed technology.

Referring to FIG. 1, the image sensing device may include a pixel region 100, a row driver 200, a correlated double sampler (CDS) 300, an analog-to-digital converter (ADC) 400, an output buffer 500, a column driver 600, and a timing controller 700. The components of the image sensing device illustrated in FIG. 1 are discussed by way of example only, and this patent document encompasses numerous other changes, substitutions, variations, alterations, and modifications. In this patent document, the word “pixel” can be used to indicate an image sensing pixel that is structured to detect incident light to generate electrical signals carrying images in the incident light.

The pixel region 100 may include a plurality of unit pixels (PXs) consecutively arranged in rows and columns. The unit pixels (PXs) may be connected to the row driver 200 through a plurality of row lines, and may also be connected to a correlated double sampler 300 through a plurality of column lines. Each unit pixel (PX) may generate a pixel signal by converting incident light into an electric signal corresponding thereto, and may output the pixel signal to the CDS 300 through the column lines. The unit pixels (PXs) may operate by receiving pixel control signals, such as a transfer control signal, a reset control signal, a gain control signal, and a selection control signal, from the row driver 200. The unit pixels (PXs) may operate in a mode selected from a plurality of operation modes.

The row driver 200 may generate pixel control signals based on control signals provided from a control circuit such as the timing controller 700 to operate the unit pixels (PXs). The row driver 200 may select at least one unit pixel connected to at least one row line of the pixel region 100 using a selection control signal. The row driver 200 may control or adjust a transfer control signal, a reset control signal, and gain control signals for the unit pixels (PXs) of the selected row line. In some implementations, the row driver 200 may receive, from a mode selector 710, a mode selection signal for selecting an operation mode of the unit pixels (PXs), and may adjust a conversion gain and a well capacity (WC) of the unit pixels (PXs) in response to the mode selection signal so that the conversion gain and the well capacity (WC) can correspond to the selected operation mode. For example, the row driver 200 may selectively output gain control signals to adjust the conversion gain, and may adjust the level of an off-voltage (V_{off}) of the transfer control signal to vary the well capacity (WC). In some implementations, the transfer control signal is applied to a gate terminal of a transfer transistor configured to transfer photocharge generated by a photoelectric conversion element, such as a photodiode (PD) in the unit pixels (PXs), and the off-voltage (Voff) of the transfer control signal can be a gate voltage of the transfer transistor when it is in an “off” state.

The correlated double sampler (CDS) 300 may remove undesired offset values of the unit pixels using correlated double sampling. In one example, the correlated double sampler (CDS) 300 may remove the undesired offset values of the unit pixels by comparing output voltages of pixel signals (of the unit pixels) obtained before and after photocharges generated by incident light are accumulated in the sensing node (e.g., a floating diffusion (FD) node).

The ADC 400 may convert analog CDS signals received for each column from the CDS 300 into digital signals, and may output the digital signals. In some implementations, the ADC 400 may be implemented as a ramp-compare type ADC.

The output buffer 500 may temporarily store column-based image data provided from the ADC 400 based on control signals of the timing controller 700.

The column driver 600 may select a column of the output buffer 500 upon receiving a control signal from the timing controller 700, and may sequentially output image data temporarily stored in the selected column of the output buffer 500.

The timing controller 700 may generate signals for controlling operations of the row driver 200, the ADC 400, the output buffer 500 and the column driver 600. The timing controller 700 may provide the row driver 200, the column driver 600, the ADC 400, and the output buffer 500 with a clock signal required for the operations of the respective components of the image sensing device, a control signal for timing control, and address signals for selecting a row or column.

The timing controller 700 may include a mode selector 710. The mode selector 710 may select an operation mode of the unit pixels (PXs) of the pixel region 100, may generate control signals (mode selection signals) corresponding to the selected operation mode, and may output the control signals to the row driver 200. In some implementations, the operation modes of each unit pixel may correspond to a plurality of conversion gains (e.g., a high conversion gain (HCG), a medium conversion gain (MCG), a low conversion gain (LCG), etc.), thereby generating a high dynamic range (HDR) image. In some implementations, the conversion gain may refer to a rate at which photocharges generated in response to the intensity of incident light are converted into a voltage of a pixel signal (PS). In some implementations, the conversion gain reflects the conversion efficiency of converting the electrical charge (e.g., photocharge) generated in response to incident light into a voltage signal at the sensing node and a higher conversion gain indicates a higher conversion efficiency.

All unit pixels included in the pixel region 100 may operate in the same operation mode as a whole, but the scope of the disclosed technology is not limited thereto. For example, some unit pixels of the pixel region 100 may operate in a specific mode, and the remaining pixels may operate in a mode different from the specific mode.

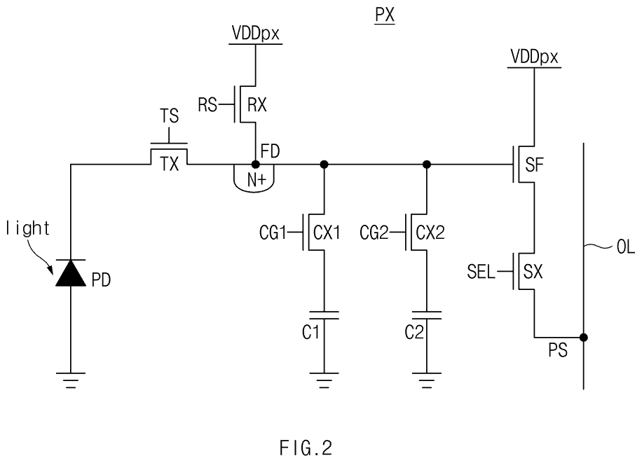

FIG. 2 is a circuit diagram illustrating an example of the unit pixel (PX) formed in the pixel region 100 of FIG. 1 based on some implementations of the disclosed technology.

Referring to FIG. 2, the unit pixel (PX) may correspond to an example of a unit pixel included in the pixel region 100 of FIG. 1.

The unit pixel (PX) may include a photoelectric conversion element (PD), a transfer transistor (TX), a reset transistor (RX), a floating diffusion region (FD), first and second conversion gain (CG) transistors (CX1, CX2), first and second capacitors (C1, C2), a source follower transistor (SF), and a selection transistor (SX).

Although the unit pixel (PX) of FIG. 2 is illustrated as including a single photoelectric conversion element (PD) as an example, the disclosed technology is not limited thereto, and the unit pixel (PX) implemented based on another embodiment may be a shared pixel having a plurality of photoelectric conversion elements. In this case, the shared pixel may include a plurality of transfer transistors respectively corresponding to the plurality of photoelectric conversion elements.

The photoelectric conversion element (PD) may generate and accumulate photocharges corresponding to the intensity of incident light. The capacity of the photoelectric conversion element (PD) to accumulate photocharges may refer to a well capacity (WC). The photoelectric conversion element (PD) may be implemented as a photodiode, a phototransistor, a photogate, a pinned photodiode, or a combination thereof.

When the photoelectric conversion element (PD) is implemented as a photodiode, the photoelectric conversion element (PD) may be a region that is doped with impurities of a second conductivity type (e.g., N-type impurities) within a substrate having a first conductivity type (e.g., P-type).

The transfer transistor (TX) may transfer photocharges (e.g., electrons) generated by the photoelectric conversion element (PD) to the floating diffusion region (FD) based on a transfer control signal (TS) from the row driver 200. The transfer transistor (TX) may include a switching element (e.g., an NMOS transistor) in which source/drain terminals are respectively connected to the photoelectric conversion element (PD) and the floating diffusion region (FD) so that the switching element can be turned on or off in response to the transfer control signal (TS) applied to a gate terminal of the switching element. In some implementations, the level of the off-voltage (V_{off}) of the transfer control signal (TS) that turns off the transfer transistor (TX) can be varied by the row driver 200 depending on the operation mode of the unit pixel (PX).

The reset transistor (RX) may reset the floating diffusion region (FD) to a power-supply voltage (VDDₚₓ) based on the reset signal (RS). The reset transistor (RX) may include a switching element (e.g., an NMOS transistor) that includes source/drain terminals connected to the power-supply voltage (VDDₚₓ) and the floating diffusion region (FD), respectively, and is turned on or off in response to a reset control signal(S) received from the gate terminal thereof.

The floating diffusion region (FD) may accumulate photocharges generated by the photoelectric conversion element (PD) and transmitted through the transfer transistor (TX). The floating diffusion region (FD) may be a diffusion region commonly connected to the transfer transistor (TX) and the reset transistor (RX). The floating diffusion region (FD) may be a region that is doped with impurities of a second conductivity type (e.g., N-type impurities) within the substrate having a first conductivity type (e.g., P-type). The floating diffusion region (FD) may be modeled as a capacitor having a unique capacitance (C_{FD}).

A first CG transistor (CX1) may selectively connect the first capacitor (C1) to the floating diffusion region (FD) based on a first gain control signal (CG1) received from the row driver 200. The first CG transistor (CX1) may include an NMOS transistor that includes source/drain terminals connected to the floating diffusion region (FD) and the first capacitor (C1), respectively. The first CG transistor (CX1) may include an NMOS transistor that can be turned on or off in response to the first gain control signal (CG1) received from the gate terminal thereof. The first capacitor (C1) may have a first capacitance (C_{C1}).

When the first CG transistor (CX1) is turned on, the first capacitor (C1) is connected in parallel to the floating diffusion region (FD), which can increase the total capacitance (Cₜₒₜₐₗ) of the floating diffusion region (FD). For example, the total capacitance (Cₜₒₜₐₗ) of the floating diffusion region (FD) may be the sum of the unique capacitance (C_{FD}) of the floating diffusion region (FD) and the first capacitance (C_{C1}) of the first capacitor (C1).

A second CG transistor (CX2) may selectively connect the second capacitor (C2) to the floating diffusion region (FD) based on a second gain control signal (CG2) received from the row driver 200. The second CG transistor (CX2) may include an NMOS transistor that includes source/drain terminals connected to the floating diffusion region (FD) and the second capacitor (C2), respectively. The second CG transistor (CX2) may include an NMOS transistor that can be turned on or off in response to the second gain control signal (CG2) received from the gate terminal thereof. The first capacitor (C1) may have a first capacitance (C_{C1}). The second capacitor (C2) may have a second capacitance (CC2). The second capacitance (C_{C2}) may be greater than the first capacitance (C_{C1}).

When the second CG transistor (CX2) is turned on, the second capacitor (C2) is connected in parallel to the floating diffusion region (FD), which can increase the total capacitance (Cₜₒₜₐₗ) of the floating diffusion region (FD). For example, the total capacitance (Cₜₒₜₐₗ) of the floating diffusion region (FD) may be the sum of the unique capacitance (C_{FD}) of the floating diffusion region (FD) and the second capacitance (C_{C2}) of the first capacitor (C1).

Each of the first capacitor (C1) and the second capacitor (C2) may include at least one of a Metal-Insulator-Metal (MIM) capacitor, a Metal-Insulator-Polysilicon (MIP) capacitor, a Metal-Oxide-Semiconductor (MOS) capacitor, or a junction capacitor. The capacitance (C_{C1}) of the first capacitor (C1) and the capacitance (C_{C2}) of the second capacitor (C2) can be pre-determined experimentally to satisfy the sensitivity required in the operation mode of the unit pixel (PX), which will be described below.

The source follower transistor (SF) may generate a pixel signal (PS) corresponding to a voltage change of the floating diffusion region (FD) and transmit the pixel signal (PS) to the selection transistor (SX). The source follower transistor (SF) may include a switching element (e.g., an NMOS transistor) that includes source/drain terminals connected to the power-supply voltage (VDDₚₓ) and the selection transistor (SX), respectively. The source follower transistor (SF) may include a switching element (e.g., an NMOS transistor) that is connected to the floating diffusion region (FD) through a gate terminal thereof.

The selection transistor (SX) may transmit the pixel signal (PS) received from the source follower transistor (SF) to an output signal line (OL) based on the selection signal (SEL) received from the row driver 200.

The selection transistor (SX) may include a switching element (e.g., an NMOS transistor) that includes source/drain terminals connected to the source follower transistor (SF) and the output signal line (OL), respectively. The selection transistor (SX) may include a switching element (e.g., an NMOS transistor) that can be turned on or off in response to the selection control signal (SEL) received through a gate terminal thereof.

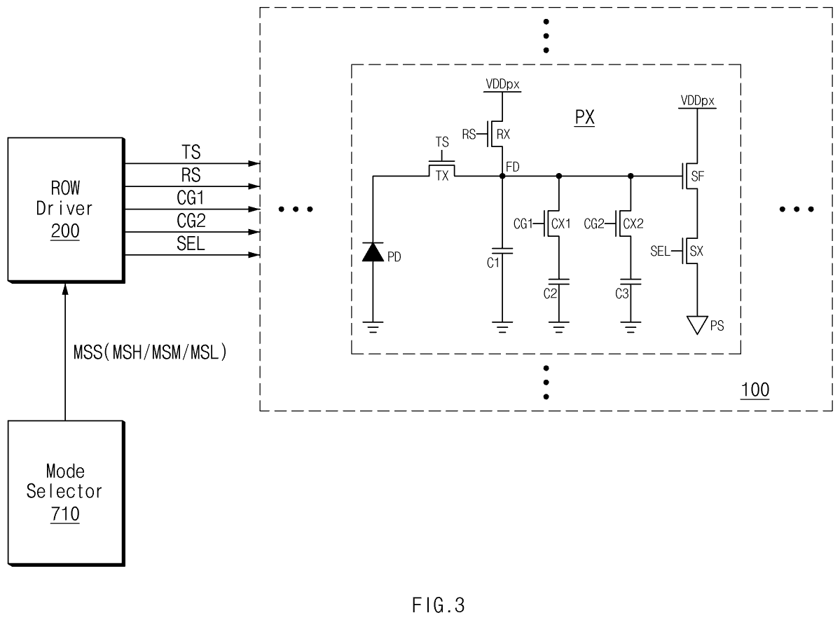

FIG. 3 is a circuit diagram schematically illustrating configurations for changing light-receiving characteristics of the unit pixels in the image sensing device of FIG. 1 based on some implementations of the disclosed technology.

Referring to FIG. 3, the mode selector 710 may select an operation mode of the unit pixel (PX) and generate a mode selection signal (MSS) corresponding to the selected operation mode, which may then be output to the row driver 200. For example, the mode selector 710 may output one of a mode selection signal (MSH) corresponding to a high conversion gain (HCG) mode, a mode selection signal (MSM) corresponding to a medium conversion gain (MCG) mode, and a mode selection signal (MSL) corresponding to a low conversion gain (LCG) mode as the mode selection signal (MSS).

The mode selector 710 may select an operation mode of a unit pixel 200 either under the control of an external device (e.g., an image processor) or based on a predetermined algorithm. For example, the mode selector 710 may select the operation mode of the unit pixel 200 based on a predetermined algorithm, depending on a user input, sensing data obtained from an external sensor (e.g., an illuminance sensor), or characteristics and operation conditions of the image sensor. In some implementations, the characteristics and operation conditions of the image sensor may include internal setting values of the image sensor, such as an analog gain, an optical integration time, an ADC (analog digital converter) input range, etc.

In addition, the mode selector 710 may have the unit pixels (PXs) within the pixel region 100 operate in the same operation mode across all unit pixels, or may have the unit pixels (PXs) operate in different operation modes.

The mode selector 710 may be formed within the timing controller 700 as shown in FIG. 1. Alternatively, the mode selector 710 may be formed as a separate component separated from the timing controller 700.

The row driver 200 may generate pixel control signals (TS, RS, CG1, CG2, SEL), and may output the pixel control signals (TS, RS, CG1, CG2, SEL) to the unit pixels (PXs) of the pixel region 100. Here, the row driver 200 may control the voltage level of the transfer control signal (TS), among the pixel control signals, based on the mode selection signal (MSS) received from the mode selector 710, and, for the gain control signals (CG1, CG2), the row driver 200 may control whether the signal is activated (enabled) based on the mode selection signal (MSS). For example, the row driver 200 may adjust the level of the off-voltage (V_{off}) of the transfer control signal (TS) based on the mode selection signal (MSS). In some implementations, the off-voltage (V_{off}) may refer to a voltage that enables the transfer transistor (TX) to be turned off. In one example, the off-voltage (V_{off}) may be a negative charge pumping (NCP) voltage. In addition, the row driver 200 may selectively activate (enable) the gain control signals (CG1, CG2) based on the mode selection signal (MSS). For example, the row driver 200 may deactivate both gain control signals (CG1, CG2) or selectively activate only one of the gain control signals (CG1, CG2) based on the mode selection signal (MSS). Alternatively, the row driver 200 may activate both gain control signals (CG1, CG2) based on the mode selection signal (MSS).

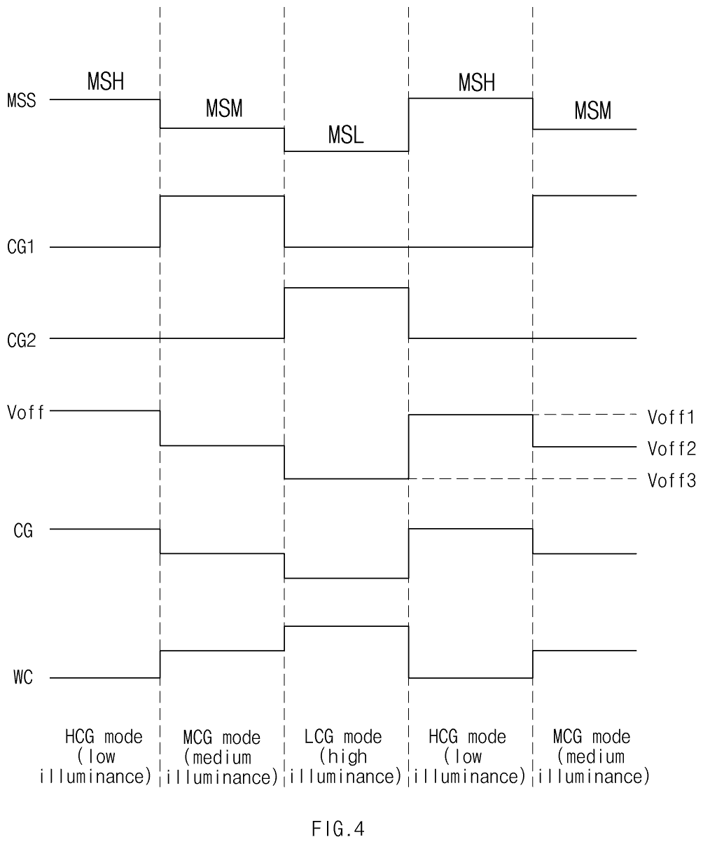

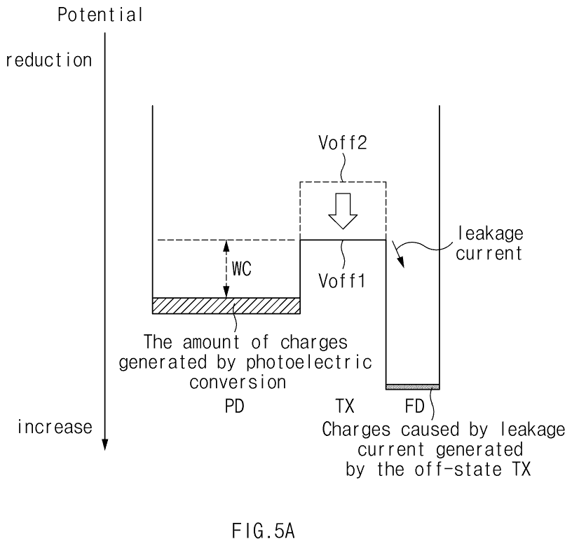

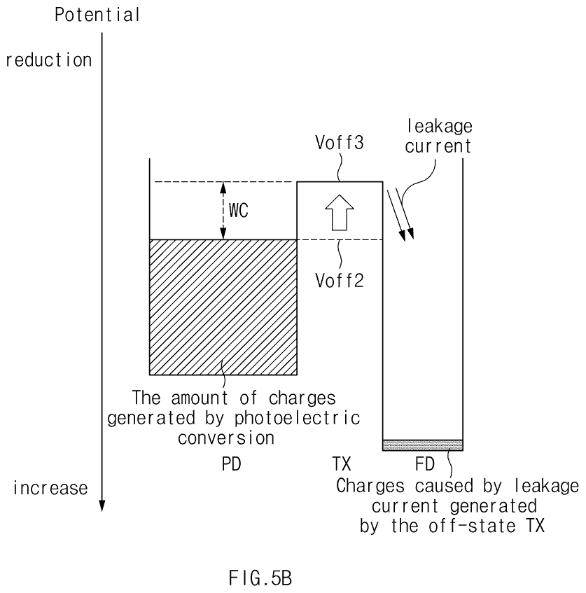

FIG. 4 is a timing diagram illustrating changes in control signals (MSS, CG1, CG2), the conversion gain (CG), the well capacity (WC), and the off-voltage (V_{off}) according to a change in the operation modes shown in FIG. 3 based on some implementations of the disclosed technology. FIG. 5A is a diagram illustrating examples of electric potential distributions of the photoelectric conversion element (PD), the transfer transistor (TX), and the floating diffusion region (FD) in a high conversion gain (HCG) mode based on some implementations of the disclosed technology. FIG. 5B is a diagram illustrating examples of electric potential distributions of the photoelectric conversion element (PD), the transfer transistor (TX), and the floating diffusion region (FD) in a low conversion gain (LCG) mode based on some implementations of the disclosed technology.

A method for changing light-receiving characteristics of the unit pixels in the image sensing device of FIG. 1 will hereinafter be described with reference to FIGS. 3, 4, 5A and 5B.

As shown in FIG. 3, each unit pixel (PX) may operate in a plurality of operation modes based on pixel control signals (TS, RS, CG1, CG2, SEL) received from the row driver 200. For example, each unit pixel (PX) may operate in the HCG mode with a high conversion gain, the MCG mode with a medium conversion gain, and the LCG mode with a low conversion gain. The conversion gain can be determined by a combination of capacitance of the floating diffusion region (FD) and capacitances of the capacitors (C1, C2). In some implementations, the floating diffusion region (FD) is a region where photocharges are accumulated and converted into the pixel signal (PS).

In a situation where the capacitance of the floating diffusion region (FD) is relatively small, when photocharges are accumulated in the floating diffusion region (FD), a voltage change in the floating diffusion region (FD) may be relatively large. Accordingly, the voltage change of the electrical signal generated by the source follower transistor (SF) can also be relatively large, which can increase a conversion gain of the unit pixel (PX).

In a situation where the capacitance of the floating diffusion region (FD) is relatively large, when photocharges are accumulated in the floating diffusion region (FD), a voltage change in the floating diffusion region (FD) may be relatively small. Accordingly, the voltage change of the electrical signal generated by the source follower transistor (SF) can also be relatively small, which can decrease a conversion gain of the unit pixel (PX).

The HCG mode is an operation mode with relatively high sensitivity to incident light, making it suitable for capturing low-illuminance scenes. For example, the HCG mode may be an operation mode corresponding to a high conversion gain (HCG).

In the low-illuminance environment, the mode selector 710 may select and output a mode selection signal (MSH) corresponding to the HCG mode as a mode selection signal (MSS), to the row driver 200. The mode selector 710 may select and output a mode selection signal (MSH) corresponding to the shooting conditions based on a preset algorithm that is determined based on a user input, data acquired through an external sensor (e.g., an illuminance sensor), the characteristics and operation conditions of the image sensor.

When the row driver 200 receives the mode selection signal (MSH) from the mode selector 710, the row driver 200 may control the output of pixel control signals so that the unit pixels (PXs) operate in the HCG mode.

For example, in the HCG mode, as shown in FIG. 4, the row driver 200 may turn off both the first conversion gain (CG) transistor (CX1) and the second conversion gain (CG) transistor (CX2) by deactivating both the first gain control signal (CG1) and the second gain control signal (CG2). Accordingly, the total capacitance (Cₜₒₜₐₗ) of the floating diffusion region (FD) may become unique capacitance (C_{FD}) of the floating diffusion region (FD).

In addition, as shown in FIG. 5A, the row driver 200 may lower an electric potential barrier between the photoelectric conversion element (PD) and the floating diffusion region (FD) by increasing the off-voltage (V_{off}) of the transfer control signal (TS) to a first off-voltage level (V_{off1}). In a low-illuminance environment, the amount of photocharges generated by the photoelectric conversion element (PD) is small, so that the well capacity (WC) of the photoelectric conversion element (PD) may become excessively large. In addition, since the amount of photocharges generated by the photoelectric conversion element (PD) is small, the pixel signal may be much affected by a leakage current generated when the transfer transistor (TX) is turned off. Furthermore, in an embodiment, due to conversion gain control, the capacitance of the floating diffusion region (FD) in the HCG mode is smaller than the capacitance of the floating diffusion region (FD) in other operation modes (MCG, LCG), so that the influence of the leakage current on such capacitance may become relatively larger.

The leakage current generated when the transfer transistor (TX) is turned off may decrease as the off-voltage (V_{off}) of the transfer transistor (TX) increases. In FIGS. 5A and 5B, the amount of leakage current flowing from the transfer transistor (TX) into the floating diffusion region (FD) is schematically represented using the number and length of arrows. That is, when the off-voltage (V_{off}) is high as shown in FIG. 5A, the leakage current may decrease compared to when the off-voltage (V_{off}) is low as shown in 5B. Therefore, in the HCG mode, as shown in FIG. 5A, the row driver 200 may increase the off-voltage (V_{off}) of the transfer control signal (TS) to a higher voltage level (V_{off1}) than the off-voltage in other operation modes (MCG, LCG), and may provide this off-voltage (V_{off1}) to the unit pixels (PXs). In other words, the row driver 200 may control the unit pixels (PXs) to reduce the off-state leakage current of the transfer transistor (TX) even if the well capacity (WC) of the photoelectric conversion element (PD) is reduced.

The LCG mode is an operation mode with relatively low sensitivity to incident light, making it suitable for capturing high-illuminance scenes. For example, the LCG mode may be an operation mode corresponding to a low conversion gain (LCG).

In the high-illuminance environment, the mode selector 710 may select a mode selection signal (MSL) corresponding to the LCG mode as a mode selection signal (MSS), and may output the selected MSL to the row driver 200. When the row driver 200 receives the mode selection signal (MSL) from the mode selector 710, the row driver 200 may control the output of pixel control signals so that the unit pixels (PXs) operate in the LCG mode.

For example, in the LCG mode, as shown in FIG. 4, the row driver 200 may turn off the first CG transistor (CX1) by deactivating the first gain control signal (CG1), and may turn on the second CG transistor (CX2) by activating the second gain control signal (CG2). Accordingly, since the second capacitor (C2) is connected in parallel to the floating diffusion region (FD), total capacitance (Cₜₒₜₐₗ) of the floating diffusion region (FD) may be the sum of the unique capacitance (C_{FD}) of the floating diffusion region (FD) and the second capacitance (C_{C2}) of the second capacitor (C2). Here, the second capacitance (C_{C2}) may be greater than the first capacitance (C_{C1}) of the first capacitor (C1). In addition, as shown in FIG. 5B, the row driver 200 may increase the electric potential barrier between the photoelectric conversion element (PD) and the floating diffusion region (FD) by lowering the off-voltage (V_{off}) of the transfer control signal (TS) to a third off-voltage level (V_{off3}), thereby increasing the well capacity (WC) of the photoelectric conversion element (PD). That is, in high-illuminance environments, a large amount of photocharges are generated by the photoelectric conversion element (PD), which may require a greater well capacitances for the photoelectric conversion element (PD). However, if the level of the off-voltage (V_{off}) is lowered, the leakage current flowing from the transfer transistor (TX) to the floating diffusion region (FD) may increase compared to FIG. 5A, as indicated by two long arrows in FIG. 5B. However, in high-illuminance environments, due to the large amount of photocharges generated by the photoelectric conversion element (PD), the impact of the leakage current on the pixel signal may become relatively small. Furthermore, in an embodiment, since the capacitance of the floating diffusion region (FD) in the LCG mode is larger than the capacitance of the floating diffusion region (FD) in the other operation modes (MCG, LCG) (as shown by the wider width of the floating diffusion region (FD) in FIG. 5B compared to FIG. 5A), the impact of the leakage current may become relatively small.

The row driver 200 may lower the off-voltage (V_{off}) of the transfer control signal (TS) in the LCG mode to a voltage (V_{off3}) lower than the off-voltage of other operation modes (HCG, MCG), and may provide the lowered voltage (V_{off3}) to the unit pixels. That is, in the LCG mode, the row driver 200 may control the unit pixels (PXs) to increase the well capacity (WC) of the photoelectric conversion element (PD), allowing the photoelectric conversion element (PD) to capture more light, even if the off-state leakage current of the transfer transistor (TX) increases.

The MCG mode is an operation mode with sensitivity to incident light that falls between the HCG mode and the LCG mode, making it suitable for capturing medium-illuminance scenes. For example, the MCG mode may be an operation mode corresponding to a medium conversion gain (MCG). In some implementations, the medium illuminance may refer to an illuminance condition in which the intensity of the incident light is not biased or skewed toward the high or low illuminance conditions, but instead spans a variety of illuminance ranges from high illuminance to low illuminance.

In the medium-illuminance environment, the mode selector 710 may select a mode selection signal (MSM) corresponding to the MCG mode as a mode selection signal (MSS) and may output the selected MSM to the row driver 200. When the row driver 200 receives the mode selection signal (MSM) from the mode selector 710, the row driver may control the output of the pixel control signals so that the unit pixels (PXs) can operate in the MCG mode.

For example, in the MCG mode, as shown in FIG. 4, the row driver 200 may turn off the first CG transistor (CX1) by deactivating the first gain control signal (CG1), and may turn on the second CG transistor (CX2) by activating the second gain control signal (CG2). Accordingly, since the first capacitor (C1) is connected in parallel to the floating diffusion region (FD), the total capacitance (Cₜₒₜₐₗ) of the floating diffusion region (FD) may be the sum of the unique capacitance (C_{FD}) of the floating diffusion region (FD) and the first capacitance (C_{C1}) of the first capacitor (C1).

In addition, in the MCG mode, the row driver 200 may adjust the off-voltage (V_{off}) of the transfer control signal (TS) to a second off-voltage level (V_{off2}) that is lower than the first off-voltage level (V_{off1}) and is higher than the third off-voltage level (V_{off3}), so that the row driver 200 may provide the adjusted voltage (V_{off2}) to the unit pixels (PXs). The second off-voltage level (V_{off2}) may be an average value of the first off-voltage level (V_{off1}) and the third off-voltage level (V_{off3}), but is not limited thereto. For example, the first to third off-voltage levels (V_{off1}, V_{off2}, V_{off3}) may be experimentally pre-determined experimentally to satisfy the sensitivity required in the HCG mode, the MCG mode, and the LCG mode depending on the structural characteristics of the unit pixel (PX) (e.g., the size of the photoelectric conversion element (PD), the magnitude of the capacitance (C_{FD}, C_{C1}, C_{C2}), etc.).

As described above, in an embodiment, a high dynamic range (HDR) can be implemented by adjusting the capacitance of the floating diffusion region (FD) and the level of the off-voltage (V_{off}) of the transfer transistor (TX) in response to each of the HCG mode, the MCG mode, and the LCG mode. That is, by using the HCG mode, the MCG mode, and the LCG mode together, rather than relying on a single mode, the unit pixel (PX) may achieve a high dynamic range (HDR) that spans from the lower limit of the dynamic range in the HCG mode to the upper limit of the dynamic range in the LCG mode. Here, the dynamic range may refer to the range of the intensity (or light quantity) of the incident light over which the unit pixel (PX) can produce an effective response that represents the intensity of the incident light.

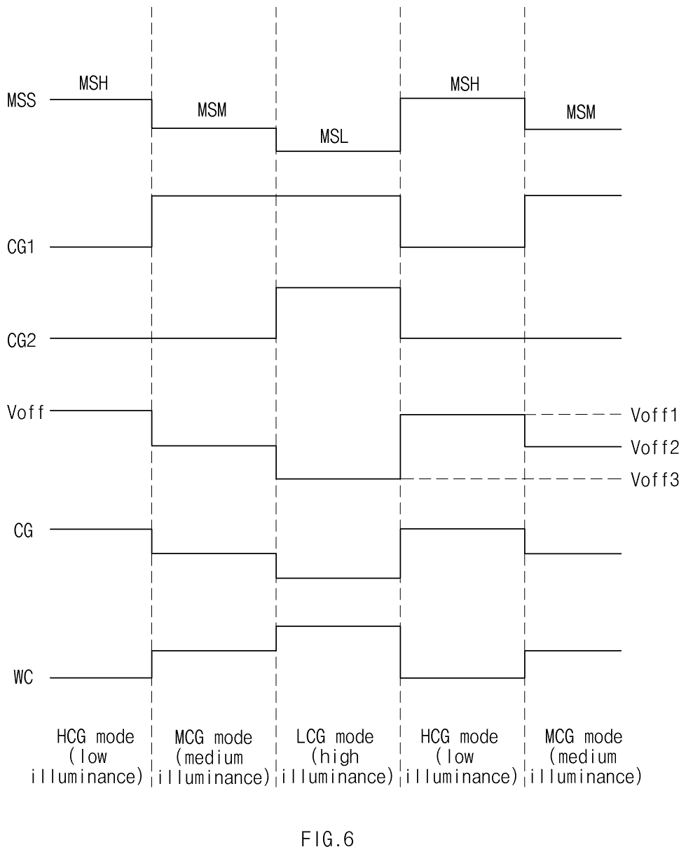

FIG. 6 is a timing diagram illustrating example of state changes of control signals (MSS, CG1, CG2), a conversion gain (CG), a well capacity (WC), and an off-voltage (V_{off}) based on some other implementations of the disclosed technology.

Referring to FIG. 6, unlike FIG. 4, the first gain control signal (CG1) may be activated to a high level not only in the MCG mode but also in the LCG mode. In FIG. 4, in the LCG mode, the first gain control signal (CG1) is deactivated and the second gain control signal (CG2) is activated, so that only the second capacitor (C2) can be connected in parallel to the floating diffusion region (FD). However, as shown in FIG. 6, the row driver 200 may activate both the first gain control signal (CG1) and the second gain control signal (CG2) in the LCG mode, so that both the first capacitor (C1) and the second capacitor (C2) can be connected in parallel to the floating diffusion region (FD).

In this case, the total capacitance (Cₜₒₜₐₗ) of the floating diffusion region (FD) may be the sum of unique capacitance (C_{FD}) of the floating diffusion region (FD), the first capacitance (C_{C1}) of the first capacitor (C1), and the second capacitance (C_{C2}) of the second capacitor (C2). Accordingly, the capacitance of the floating diffusion region (FD) in the LCG mode can be increased by using the same capacitors (C1, C2).

Although FIG. 6 illustrates only the case where the first capacitor (C1) is connected to the floating diffusion region (FD) in the MCG mode as an example, the disclosed technology is not limited thereto, and the second capacitor (C2) may also be connected to the floating diffusion region (FD). For example, the row driver 200 may further adjust the conversion gain of the MCG mode by selectively connecting either the first capacitor (C1) or the second capacitor (C2), which have different capacitances, to the floating diffusion region (FD).

In the above example, the unit pixels (PXs) included in the pixel region 100 operate in the same operation mode. However, the disclosed technology is not limited thereto, and the unit pixels (PXs) may also operate in different operation modes from one another. For example, the pixel region 100 may be divided into a plurality of regions in advance, and the row driver 200 may control the unit pixels (PXs) to operate in different operation modes for each divided region.

In the above example, one of the three signals (MSH, MSM, MSL) is selected and output as the mode selection signal (MSS). However, by subdividing the mode selection signal (MSS), more diverse forms of control may be achieved. In the above example, the unit pixel utilizing three different conversion gains is described as an example. However, the disclosed technology may also be implemented in some embodiments to use two or more different conversion gains.

For example, although FIG. 2 illustrates the unit pixel (PX) as including two capacitors (C1, C2) and two CG transistors (CG1, CG2), the disclosed technology is not limited thereto, and only one capacitor (C1 or C2) and only one CG transistor can be included in the unit pixel so that the unit pixel can operate in two conversion modes.

In addition, the structure of the unit pixel using three different conversion gains, as illustrated in FIG. 2, is merely an example, and the disclosed technology is not limited thereto.

In this way, the image sensing device based on some implementations of the disclosed technology can improve the operating characteristics by modifying light-receiving characteristics depending on the photography setting or shooting environment.

While various embodiments have been described above as specific examples for implementing those embodiments, variations and modifications of those embodiments and other embodiments can be made based on what is disclosed and illustrated in this patent document.

What is claimed is:

1. An image sensing device comprising:
a pixel region including unit pixels configured to convert incident light into an electrical signal; and
a row driver configured to adjust a well capacity of a photoelectric conversion element disposed in at least one of the unit pixels and a conversion gain of the at least one of unit pixels for converting photocharge generated in response to incident light into a voltage of a pixel signal at each unit pixel to correspond to a selected operation mode in response to a mode selection signal that selects an operation mode of the unit pixels.

2. The image sensing device according to claim 1, wherein the at least one of the unit pixels includes:
a photoelectric conversion element configured to convert the incident light into photocharges; and
a transfer transistor configured to transfer the photocharges generated by the photoelectric conversion element to a floating diffusion region in response to a transfer control signal received from the row driver.

3. The image sensing device according to claim 2, wherein the row driver is configured to:
adjust a level of an off-voltage of the transfer control signal that turns off the transfer transistor to generate an adjusted level of the off-voltage corresponding to the selected operation mode.

4. The image sensing device according to claim 3, wherein the off-voltage includes:
a negative charge pumping (NCP) voltage.

5. The image sensing device according to claim 3, wherein:
a plurality of operation modes includes a high conversion gain (HCG) mode, a low conversion gain (LCG) mode, and a medium conversion gain (MCG) mode,
wherein the row driver raises the level of the off-voltage in the HCG mode to be higher than the level of the off-voltage in the MCG mode, and lowers the level of the off-voltage in the LCG mode to be lower than the level of the off-voltage in the MCG mode.

6. The image sensing device according to claim 1, wherein the at least one of the unit pixels includes:
a photoelectric conversion element configured to generate photocharges by converting incident light into the photocharges;
a transfer transistor configured to transfer the photocharges generated by the photoelectric conversion element to a floating diffusion region based on a transfer control signal received from the row driver;
at least one capacitor configured to have a predetermined capacitance; and
at least one conversion gain (CG) transistor configured to selectively connect the at least one capacitor to the floating diffusion region based on a gain control signal received from the row driver.

7. The image sensing device according to claim 6, wherein the row driver is configured to:
selectively turn on the at least one CG transistor in response to the selected operation mode.

8. The image sensing device according to claim 6, wherein:
the at least one capacitor includes a first capacitor having a first capacitance and a second capacitor having a second capacitance different from the first capacitance; and
the at least one CG transistor includes:
a first CG transistor configured to selectively connect the first capacitor to the floating diffusion region based on a first gain control signal received from the row driver; and
a second CG transistor configured to selectively connect the second capacitor to the floating diffusion region based on a second gain control signal received from the row driver.

9. The image sensing device according to claim 8, wherein the row driver is configured to:
turn off both the first CG transistor and the second CG transistor in a high conversion gain (HCG) mode;
turn off the first CG transistor and turn on the second CG transistor in a low conversion gain (LCG) mode; and
turn on the first CG transistor and turn off the second CG transistor in a medium conversion gain (MCG) mode.

10. The image sensing device according to claim 8, wherein the row driver is configured to:
turn off both the first CG transistor and the second CG transistor in a high conversion gain (HCG) mode;
turn on both the first CG transistor and the second CG transistor in a low conversion gain (LCG) mode; and
selectively turn on any one of the first CG transistor and the second CG transistor in a medium conversion gain (MCG) mode.

11. The image sensing device according to claim 1, further comprising:
a mode selector configured to select one of the mode selection signals respectively corresponding to a plurality of operation modes and output the selected mode selection signal to the row driver.

12. The image sensing device according to claim 1, wherein the row driver is configured to:
control the unit pixels to operate in a same operation mode.

13. The image sensing device according to claim 1, wherein the row driver is configured to:
control the unit pixels to operate in different operation modes for each pre-divided region in the pixel region.

14. An image sensing device comprising:
a photoelectric conversion element configured to generate photocharges in response to incident light;
a transfer transistor configured to transfer the photocharges generated by the photoelectric conversion element to a floating diffusion region based on a transfer control signal;
a first capacitor having a first capacitance;
a second capacitor having a second capacitance different from the first capacitance;
a first conversion gain (CG) transistor configured to selectively connect the first capacitor to the floating diffusion region based on a first gain control signal; and
a second conversion gain (CG) transistor configured to selectively connect the second capacitor to the floating diffusion region based on a second gain control signal.

15. The image sensing device according to claim 14, wherein:
the first gain control signal and the second gain control signal are selectively activated based on a mode selection signal to turn on or off the first CG transistor and the second CG transistor.

16. The image sensing device according to claim 15, wherein a row driver is configured to:
turn off both the first CG transistor and the second CG transistor in a high conversion gain (HCG) mode;
turn off the first CG transistor and turn on the second CG transistor in a low conversion gain (LCG) mode; and
turn on the first CG transistor and turn off the second CG transistor in a medium conversion gain (MCG) mode.

17. The image sensing device according to claim 15, wherein a row driver is configured to:
adjust a level of an off-voltage of the transfer control signal based on the mode selection signal.

18. The image sensing device according to claim 17, wherein:
the row driver increases the level of the off-voltage in a high conversion gain (HCG) mode to be higher than the level of the off-voltage in a medium conversion gain (MCG) mode, and lowers the level of the off-voltage in a low conversion gain (LCG) mode to be lower than the level of the off-voltage in the MCG mode.
